(19) United States
(12) Patent Application Publication
(10) Pub. No.: US 2003/0175385 A1
(43) Pub. Date: Sep. 18, 2003

(54) Unique fat based ganache coating for the surface of packaged frozen products

(76) Inventors: John D. Helferich, Chester, NJ (US); Richard W. Benson, Lake Forest, IL (US); Laura Saran, Woodridge, IL (US)

Correspondence Address: FITZPATRICK CELLA HARPER & SCINTO, 30 ROCKEFELLER PLAZA, NEW YORK, NY, 10112, US

(21) Appl. No.: 10/175,384

(22) Filed: Jun. 18, 2002

Related U.S. Application Data
(60) Provisional application No. 60/365,751, filed on Mar. 18, 2002.

(51) Int. Cl. A23G 3/00

(52) U.S. Cl. 426/91

(57) ABSTRACT

The present invention is directed to a packaged frozen product, comprising (a) an edible frozen matrix, and (b) a fat based ganache coating comprising a compound coating, an edible oil, and water that is applied to at least one surface of the edible frozen matrix, wherein the fat based ganache coating has a penetration hardness at −5° C. of from about 4,400 to about 12,000 grams of force.

### CROSS-REFERENCE TO RELATED APPLICATIONS

This application claims the benefit of U.S. Provisional Patent Application Serial No. 60/365,751, filed Mar. 18, 2002, which is incorporated by reference.

### BACKGROUND OF THE INVENTION

1. Field of the Invention

The present invention is directed to packaged frozen products, such as packaged ice cream or frozen novelties that have a unique fat based ganache coating covering an edible frozen matrix, such as ice cream.

2. Related Background Art

Many ice cream products are made with (a) 0 to 18% milkfat; (b) between 5 and 14% milk solids, which contains proteins such as caseins and whey proteins; (c) 12% to 20% sweeteners, such as sucrose and glucose-based corn syrup sweeteners; and (d) 0.2% to 0.5% stabilizers and emulsifiers. Water makes up the remaining percentage, which is roughly 55% to 64% of the product. Additionally, there are ice cream products that are formulated within the standard of identity, which have milkfat levels from 0% or higher, some as high as 20%.

There are many frozen novelty products available for consumers to choose from. For example, ice cream, sherbert, sorbet, frozen yogurt, frozen custard, and frozen dairy desserts, can be found in the freezer section of supermarkets. However, as time changes, so does the consumer's taste. It is important for companies that manufacture such products to create new innovative frozen products to keep consumers interested and meet their new expectations. Toppings and coatings have been applied to many frozen novelty products, but their texture is either too soft or too hard.

For example, in U.S. Pat. No. 6,174,555 to Leas et al. discloses a water-containing chocolate composition, which is suitable for use with an ice confectionery composition. The water-containing chocolate composition is an admixture of chocolate and a water-in-oil emulsion which includes a vegetable oil and milk fat. The composition has water present in an amount of from 10% to 30%, fat substances present in an amount of from 35% to 45%, and carbohydrates present in an amount of from 30% to 40% (by weight). The fat substances consist of 5 to 15% vegetable oil, 5 to 15% milk fat and 20 to 30% cocoa butter or cocoa butter replacers. The resulting water-containing chocolate composition has a soft fudge like texture.

To generate interest in frozen novelty products, new innovative toppings and/or coatings that provided a unique textural eating experience are needed.

### SUMMARY OF THE INVENTION

The present invention is directed to a frozen product, comprising (a) an edible frozen matrix, and (b) a fat based ganache coating comprising a compound coating, an edible oil, and water that is applied to at least one surface of the edible frozen matrix, wherein the fat based ganache coating has a penetration hardness at −5° C. of from about 4,400 to about 12,000 grams of force. Preferably, the edible frozen matrix is ice cream.

The present invention also includes a method of making a frozen product. The method comprises the steps of: (a) providing an edible frozen matrix, and (b) applying a fat based ganache coating comprising a compound coating, an edible oil, and water, to at least one surface of the edible frozen matrix, wherein the fat based ganache coating has a penetration hardness at −5° C. of from about 4,400 to about 12,000 grams of force.

Another aspect of the present invention is a method of reducing ice crystal formation in a packaged frozen product. The method comprises the steps of: (a) providing a package having an opening, wherein the package is suitable for storing a frozen product; (b) depositing an edible frozen matrix into the package; (c) applying a fat based ganache coating comprising a compound coating, an edible oil, and water, to at least one surface of the edible frozen matrix, wherein the fat based ganache coating has a penetration hardness at −5° C. of from about 4,400 to about 12,000 grams of force; and (d) sealing the package to fully surround the edible frozen matrix and the fat based ganache coating, thereby substantially reducing the formation of ice crystals.

In a preferred embodiment, the present invention is a fat based ganache coating comprising (a) about 50 wt. % to about 85 wt. % of a compound coating, (b) about 10 wt. % to about 30 wt. % of an edible oil, and (c) about 5 wt. % to about 25 wt. % of water wherein the ganache coating has a penetration hardness at −5° C. of from about 4,400 to about 12,000 grams of force.

### DETAILED DESCRIPTION OF THE INVENTION

The present invention is directed to a frozen product, such as a packaged frozen product, that contains an edible frozen matrix, e.g., ice cream, with a fat based ganache coating or layer that covers at least a portion of a surface of the edible frozen matrix. The fat based ganache coating is comprised of a compound coating, an edible oil, and water. Optionally, the packaged frozen product may include confectionery pieces, baked goods, sauces and variegates, nut meats, fruit pieces, and the like.

For the purposes of this invention, an edible frozen matrix is understood to include any edible matrix that is stored or preserved in a freezer or under similar conditions, e.g., from about −28.9° C. to about −15° C., or any other material which is edible at the temperatures required for ice cream type products. For example, the edible frozen matrix may be ice cream, sherbert, frozen yogurt, frozen custard, sorbet, mellorine, frozen dairy desserts, and the like. Non-limiting examples of ice cream include nonfat, lowfat, light, reduced fat, and the like.

The frozen product of the present invention has a layer of a fat based ganache coating (e.g., a specially formulated chocolate, ganache, and the like) that completely or partially covers at least one surface of an edible frozen matrix. The fat based ganache coating may be applied to any surface of the edible frozen matrix. Preferably, the top surface of the edible frozen matrix is covered by the fat based ganache coating. Alternatively, the fat based ganache coating may completely or substantially surround the edible frozen matrix.

Unlike other coatings and toppings that have been placed on the surface of frozen novelty products, the fat based ganache coating of the present invention provides a unique texture that is brittle and smooth.

The consistency of the fat based ganache coating should be such that it can be readily cut by a utensil, such as a spoon or scoop, without displacing the remaining fat based ganache coating. As the utensil cuts through the fat based ganache coating, a slight snapping or crackling sound may be heard and visible surface cracks around the area become apparent. The fat based ganache coating may also have a texture that is somewhat similar to the center of a truffle.

An objective textural measurement to quantify the texture of this material is performed using a texture analyzer, such as the TA.XT2i Texture Analyzer from Texture Technologies of Scarsdale, N.Y. Texture analyzers are well known instruments that are widely used in the food industry to characterize various types of food products, such as gels, gums, nuts, confectionery products, fruits and vegetables, meat and fish products, and the like. Using a texture analyzer, a fracture, hardness, or gradient value can be obtained. The hardness value is the peak force measured during the sample test.

The following procedure was used to evaluate the hardness of the fat based ganache coating using the TA.XT2i Texture Analyzer with a 20° angle stainless steel cone probe (10° off center).

Sample Preparation:

1. Warm fat based ganache coating to 37.8° C.

2. Deposit 74 g of the warmed fat based ganache coating into a weigh boat (available from Cole Palmer—part no. U0101715, 3.5 in.×3.5 in×1 in.).

3. Place the weigh boat into a cabinet at a temperature setting of −20° C. for 5 hr. (hardening step).

4. Transfer the weigh boat into a cabinet at a temperature setting of −5° C. for 24 hr. (post conditioning).

Analysis:

1. Set Peltier cabinet* to −5° C.

2. Remove sample from weigh boat and place sample in Peltier cabinet.

3. Load and transfer the hardness (penetration) program** to the instrument.

4. Analyze each sample in triplicate.

Data Analysis:

Evaluate force at −5° C. and record as grams of force. *The Peltier cabinet is a temperature controlled chamber that has a temperature controlled surface contained within the chamber and is available from Texture Technologies. **The hardness program is a set of instructions that sets the probe speed as follows:

a. pretest speed of 2.0 mm/sec (travel speed prior to contacting sample)

b. test speed at 2.0 mm/sec (travel speed through sample)

c. post test speed at 2.00 mm/sec (travel speed of withdrawal from sample)

The probe is set to penetrate the sample to a depth of 80% of the overall sample depth.

While the ganache should have some hardness characteristics to it, e.g., somewhat like tempered chocolate, pliability is also a desired characteristic. Accordingly, the penetration hardness range of the fat based ganache coating is from about 4,400 to about 12,000 grams of force. Preferably, from about 4,400 to about 8,000 grams of force, more preferably, from about 5,000 to about 8,000 grams of force, and most preferably, from about 6,000 to about 8,000 grams of force.

Furthermore, the present inventors have discovered that application of the fat based ganache coating to an exposed surface of the edible frozen matrix acts as a moisture vapor barrier that protects the surface of the edible frozen matrix from vaporization and the formation of ice crystals. Packaged frozen products, such as packaged ice cream or frozen novelties, that are stored in the freezer too long tend to form ice crystals on the surface of the product. This is particularly true in the case of ice cream. Ice cream will typically have a total solids level between 35% and 45%, with a water activity of 0.82 to 0.88. In a home freezer that has defrost cycles between −12° C. and −23° C., ice crystals will develop in a previously opened, typically stabilized type packaged ice cream container after one week. The packaged ice cream containers can range in size from a pint to 1 gallon. During the cycle, ice (solid water) undergoes sublimation, and recrystallizes in another area. As ice crystals start to form, gas molecules (water vapor) created as the ice sublimes, condense in areas where ice crystals are present. The already existing ice crystals grow larger in size, which results in ice cream that has an undesirable surface appearance and texture, e.g., graininess and/or grittiness. In the present invention, the fat based ganache coating, has a low water activity level and acts as a barrier that protects the surface, e.g., top surface, from forming ice crystals. A fat based ganache coating with a low water activity level, i.e. zero, will act as a maximum barrier, preventing ice crystal growth over the normal shelf life (about one year) of the product.

Moreover, because the fat based ganache coating substantially reduces the formation of ice crystals, the use of stabilizers in the edible frozen matrix, e.g., ice cream product, is optional. That is, the fat based ganache coating provides a means for selling ice cream products that are free from stabilizers, since surface ice crystal formation is no longer an issue. This beneficial result is achieved while providing a unique textured product.

A visual test is used to determine the degree of ice crystal formation. A rating system from 1 to 5 is used to evaluated the product for ice crystal growth. If the product has no visible ice crystals, the product is given a rating of 1. A rating of 2 is assigned when there is a slight thin film of visible ice crystals that are less than 0.5 mm in diameter. A rating of 3 is given for moderately visible ice crystals that are approximately 0.5 mm to 1 mm in diameter. Heavy ice crystal formations that are about 1 mm to 2 mm in diameter are given a rating of 4. Very heavy ice crystal formation is assigned a rating of 5, where the ice crystals are greater than 2 mm in diameter.

The fat based ganache coating may be, for example, a ganache, a specially formulated chocolate, and the like.

Ganache is a term that describes a rich and creamy topping made with chocolate and heavy cream. It can be used in the centers of truffles, as a glaze over cake, or it can be whipped for use as a filling and/or frosting. Typically, a ganache is made by heating cream and adding bits of semisweet chocolate. The mixture is stirred until it becomes smooth.

For example, in one embodiment, a fat based ganache coating can be made by heating the liquid ingredients and warming the compound coating to about 37.8° C., then mixing the ingredients together. The dry ingredients are later added to form an emulsion, such as for example, an oil-in-water or water-in-oil emulsion. When forming the fat based ganache coating, attention must be given to ensure that additional heating or mixing does not detrimentally effect the emulsion. Moreover, slight changes or modifications in the water content can lead to breakdown of the emulsion, causing separation.

The fat based ganache coating (e.g., specially formulated chocolate, ganache, and the like) of the present invention is comprised of a compound coating, an edible oil, and water. In a preferred embodiment, cream is included.

An essential ingredient in the fat based ganache coating is a compound coating. The term “compound coating” is an accepted industry term that is well known to those skilled in the art and is intended to refer to all chocolate or chocolate-like compositions with a fat phase or fat-like composition. The term is intended, for example, to include standardized and non-standardized chocolates, i.e., including chocolates with compositions conforming to the U.S. Standards Of Identity (SOI) and compositions not conforming to the U.S. Standards Of Identity, respectively, including dark chocolate, baking chocolate, milk chocolate, sweet chocolate, semi-sweet chocolate, buttermilk chocolate, skim-milk chocolate, mixed dairy product chocolate, low fat chocolate, white chocolate, aerated chocolates, compound coatings, non-standardized chocolates and chocolate-like compositions, unless specifically identified otherwise.

Nonstandardized chocolates result when, for example, the nutritive carbohydrate sweetener is replaced partially or completely; or when the cocoa butter or milkfat are replaced partially or completely; or when components that have flavors that imitate milk, butter or chocolate are added or other additions or deletions in formula are made outside the FDA standards of identify of chocolate or combinations thereof. For the purposes of this invention, nonstandardized chocolates also include compound coatings that do not contain chocolate liquor, cocoa butter, and/or cocoa powder.

In addition, the compound coating may be a fruit flavored, caramel flavored or caramelized coating.

The compound coating in the fat based ganache coating has a fat content of from about 20% to about 50%, preferably, from about 20% to about 40%, and more preferably from about 20% to about 35%.

Optionally, emulsifiers may be added to the compound coating. They are, for example, lecithin and polyglycerolpolyricinoleate (PGPR). The emulsifiers coat the solid particles in the compound coating so that they can more easily move about in the fat phase of the compound coating.

The compound coating, e.g., non-standardized chocolate, is from about 50 wt. % to about 85 wt. % of the total weight of the fat based ganache coating. Preferably, from about 55 wt. % to about 75 wt. %, and more preferably, from about 60 wt. % to about 70 wt. %.

The edible oil that is used in the fat based ganache coating may be an oil or fat, or mixture thereof. Suitable oils include, but are not limited to, vegetable fats and oils such as rapeseed oil, sunflowerseed oil, cottonseed oil, peanut oil, rice oil, corn oil, safflower oil, olive oil, kapok oil, sesame oil, palm oil, sal oil, shea fat, cacao butter, coconut oil, and palm kernel oil, as well as animal fats and oils such as milk fat, beef tallow, lard, fish oil, and whale oil, and any combination thereof. Also their hardened, fractionized, or esterinterchanged form can be used. Butter, margarine, shortening, or hardbutter on market can also be used.

Preferably, the edible oil is a partially hydrogenated soybean oil, cocoa butter, illipe oil, shea oil, palm oil, sal oil, soybean oil, cottonseed oil, palm kernel oil, coconut oil, rapeseed oil, sunflower oil, and the like. In a most preferred embodiment, the edible oil is coconut oil.

The amount of edible oil that is included in the fat based ganache coating is from about 5 wt. % to about 50 wt. %, preferably from about 10 wt. % to about 30 wt. %, and more preferably from about 15 wt. % to about 20 wt. %, based on the total weight of the fat based ganache coating.

Optionally, the fat based ganache coating may include cream, which contains milk fat. In one particular embodiment, the cream is an ice cream mix comprised of milk fat, milk solids, sucrose, water, a stabilizer, and an emulsifier.

Milkfat is used to produce the rich-sensations found in ice cream. It contributes much of the overall flavor of the cream. The milk fat contribution from the cream is from about 1 wt. % to about 5 wt. % and preferably from about 1 wt. % to about 3.5 wt. %, based on the total weight of the fat based ganache coating.

In the ice cream mix, milk solids nonfat contribute to flavor, body, and texture. They also tend to mask delicate flavors, which may require that the formulation be adjusted accordingly. About 7 wt. % to about 13 wt. %, preferably from about 8 wt. % to about 12 wt. %, and more preferably from about 9 wt. % to about 11 wt. % of the ice cream mix is milk solids.

Stabilizers that are present in the ice cream mix are a group of compounds, usually polysaccharides, that are responsible for building viscosity in the unfrozen portion of the water, which serves to hold the water so that it cannot migrate within the product. The result is an ice cream that has firmness and chewiness. If the stabilizers are not included, the resulting ice cream would exhibit coarseness and an icy texture because of free water migration. The presence of free water would facilitate the growth of existing ice crystals. By immobilizing the free water, the ice cream would contain mostly small ice crystals, which are more difficult to detect. The stabilizer may be, for example, gums of various kinds, carrageenan, gelatin, guar gum, locus bean, microcrystalline cellulose, and the like. The stabilizers are from about 0.1 wt. % to about 0.4 wt. % of the total weight of the ice cream mix. Preferably, from about 0.12 wt. % to about 0.2 wt. %, and more preferably, from about 0.13 wt. % to about 0.18 wt. %.

Emulsifiers that may be used in the ice cream mix are a group of compounds which aid in developing the appropriate fat structure and air distribution necessary for the smooth eating and good meltdown characteristics. The emulsifiers are characterized by having a molecular structure which allows part of the molecule to be readily solubilized in a polar compound such as water, and another part of the molecule to be more readily solubilized in non-polar solvents such as fats. As a result, emulsifiers reside at the interface between fat and water, and lower the free energy or tension associated with two immiscible liquids in contact with each other. They are useful for producing a stiff and dry product. Typically, the resulting product will be smoother, creamier, and more melt-resistant when an emulsifier is used. Suitable emulsifiers include, but are not limited to, lecithin, glycerides, polysorbate 80, mono- and di-glycerides, and the like. The emulsifier is from about 0.025 wt. % to about 2.0 wt. % of the total weight of the ice cream mix. Preferably, from about 0.05 wt. % to about 1.0 wt. %, more preferably from about 0.1 wt. % to about 0.5 wt. % and most preferably, from about 0.10 wt. % to about 0.20 wt. %.

The ice cream mix also has sucrose, which is from about 11 wt. % to about 22 wt. % of the total weight of the ice cream mix.

In the fat based ganache coating of the present invention, water is included as a component at from about 0 wt. % to about 27 wt. %, preferably from about 5 wt. % to about 25 wt. %, and more preferably from about 5 wt. % to about 15 wt. %, of the total weight of the fat based ganache coating. The amount of water that is added has a direct impact on the texture, e.g., penetration hardness, of the fat based ganache coating.

When the fat based ganache coating includes a cream, such as an ice cream mix, water is included in the cream at from about 55 wt. % to about 65 wt. % of the total weight of the ice cream mix.

Moreover, the cream that is included in the present invention is from about 0 wt. % to about 50 wt. %, preferably from about 5 wt. % to about 40 wt. %, and more preferably from about 5 wt. % to about 30 wt. %, and most preferably from about 5 wt. % to about 10 wt. % based on the total weight of the fat based ganache coating.

An emulsifying agent may be added to the fat based ganache coating. Typically, the fat based ganache coating is an emulsion. This may create problems from drying slowly and sticking to paper wrapping or of its moisture dehydrating. Nonlimiting examples of emulsifying agents include lecithin, glycerin fatty acid ester, propylene glycol fatty acid ester, sucrose fatty acid ester, polyglycerin fatty acid ester, polyglycerin condensed ricinolate ester and the like. If an emulsifier as a component in the fat based ganache coating, it is from about 0.025 wt. % to about 0.5 wt. % of the total weight of the fat based ganache coating.

Optionally, corn syrup may be included in the fat based ganache coating to raise the solids content. It provides a desirable chewiness to the body of the product. This is likely due to the presence of dextrins, high-molecular-weight polysaccharides that remain after acid hydrolysis of the cornstarch to produce corn syrup. Not all corn syrups have the same composition; in fact, there is a considerable range depending primarily on the extent of hydrolysis used in their preparation. In the present invention, the corn syrup preferably has a dextrose equivalent (DE) of about 4 to 68, more preferably about 30 to 50. Corn syrups have a characteristic flavor of their own, and if used in excessive amounts they may interfere with the flavor of the fat based ganache. If corn syrup is included, it is from about 0 wt. % to about 25 wt. % of the total weight of the fat based ganache coating. Preferably, from about 5 wt. % to about 25 wt. %.

Optionally, additional ingredients may be included in the fat based ganache coating. For example, natural and artificial flavors, sweeteners, fruits, salt, flavor enhancers, color additives, preservatives, and the like, may be included.

In a preferred embodiment, potassium sorbate is included as the preservative in the fat based ganache coating at about 0.2 wt. % based on the total weight of the fat based ganache coating.

The total moisture content, i.e. water content, of the fat based ganache coating is from about 2% to about 30%, preferably from about 10% to about 23%, and more preferably from about 13% to about 17%.

The fat content of the fat based ganache coating is from about 30% to about 50%, preferably from about 32% to about 48%, and most preferably from about 38% to about 44% based on the total weight of the fat based ganache coating.

A particularly preferred fat based ganache coating has (a) about 85 wt. % of a compound coating; (b) about 5 wt. % of an edible oil; and (c) about 10 wt. % of water. The penetration hardness at −5° C. of this preferred embodiment is from about 4,400 to about 12,000 grams of force.

The water activity of the fat based ganache coating should be maintained or adjusted to suitable levels. In one embodiment, the water activity at 25° C. in the fat based ganache coating is from about 0.05 to about 0.88, preferably from about 0.2 to about 0.87, more preferably from about 0.4 to about 0.86, even more preferably from about 0.65 to about 0.83, and most preferably from about 0.72 to about 0.82.

In a preferred embodiment, an embossed, printed, or stamped design is applied or affixed to the top surface of the fat based ganache coating. A particularly preferred embodiment of this invention employs a chilled embosser. Embossing a chocolate composition, such as a fat based ganache coating, with a chilled embosser is described in U.S. patent application Ser. No. 09/341,429, filed Jan. 6, 2000, the disclosure of which is incorporated by reference herein.

In another preferred embodiment, the frozen novelty product may have additional coatings covering at least a portion of the edible frozen matrix. In addition, the fat based ganache coating may be flavored with one or more flavoring components, such as fruit, caramel, and the like. A coloring component may also be added to the fat based ganache coating to produce any desired color. Moreover, the fat based ganache coating may be applied to the edible frozen matrix in any random or designed pattern, with any combination of color. For example, the fat based ganache coating may be fruit flavored and applied to an ice cream layer in several different colors in the shape of an icon.

In an alternative embodiment, the frozen novelty product may have an edible cone in which the edible frozen matrix and/or fat based ganache coating may be filled. In another alternative embodiment, the frozen novelty product may be completely or substantially covered by the fat based ganache coating.

The present invention also includes a method of making a frozen product. The method comprises the steps of (a) providing an edible frozen matrix, such as ice cream, and (b) applying a fat based ganache coating comprising a compound coating, an edible oil, and water, to at least one surface of the edible frozen matrix, wherein the fat based ganache coating has a penetration hardness at −5° C. of from about 4,400 to about 12,000 grams of force. Optionally, the frozen product is placed or manufactured in a package that fully surrounds the edible frozen matrix and the fat based ganache coating.

Any suitable package may be used, so long as it is capable of storing the frozen novelty product under conditions where the temperature is from about −30° C. to about −10° C. In a preferred embodiment, the package will be sized to hold a volume of about a pint (473 ml). In addition, there is an opening in the package, which is capable of receiving the edible frozen matrix and fat based ganache coating into the package.

In one embodiment, the edible frozen matrix, e.g., ice cream, sherbert, frozen yogurt, and the like, is deposited or filled into the package. If the edible frozen matrix is in a liquid or semi-liquid state, then a filler, depositor, extruder, may be used to fill the package. Preferably, a positive displacement filler is used. If the edible frozen matrix is a solid or semi-solid block, cutting equipment may be used to properly size the edible frozen matrix to fit into the package. It should be understood that the step of depositing an edible frozen matrix into the package, includes embodiments, where, for example, (i) an edible cone, waffle, or any other edible material is first inserted or placed in contact with a wall of the package, prior to depositing or filling the ice cream, or (ii) ice cream and/or the fat based ganache coating are filled into a cone or any other edible material, prior to placement into a package.

A fat based ganache coating is then applied to a surface of the edible frozen matrix. Any suitable method may be used to apply the fat based ganache coating to the surface of the edible food matrix. For example, a depositor, filler, pump, gravity drizzler, enrober, extruder, and the like may be used. The coating may be applied such that the coating fully or partially covers a surface of the edible frozen matrix. The fat based ganache coating is applied at a temperature less than about 40° C. onto the surface. Preferably from about 0° C. to about 40° C., more preferably from about 15° C. to about 40° C. onto the surface. In one preferred embodiment, the temperature of the fat based coating is about 32° C., when applied onto the surface.

In an alternative embodiment, a preformed embossed edible material is applied onto the fat based ganache coating, where the preformed embossed edible material has a temperature of about 0° C. or less. The temperature of the fat based ganache coating is as noted above when applied to the edible frozen matrix.

Within these temperature ranges, the fat based ganache coating is somewhat viscous. It is desireable that the viscosity (at 37.8° C.) be about 3,000 cps to about 35,000 cps, preferably, about 4,000 cps to about 20,000 cps, and more preferably, about 5,000 cps to about 15,000 cps.

The thickness of the fat based ganache coating will be dependent upon product design requirements and any packaging constraints that may exist. In general, the thickness of the fat based ganache coating is between about 1 mm to about 15 mm, preferably between about 1 mm to about 5 mm, and more preferably between about 2 mm to about 3 mm.

Once the package is filled, the package is sealed. The method of sealing the package is dependent upon the package itself. For example, in one embodiment, the package is a carton with a fold over top. In another embodiment, the package is a plastic tub that is sealed by placing a plastic lid onto the tub. Other materials may be used, so long as they provide the necessary barrier protection that is required for storing a product under freezer conditions. In a preferred embodiment, bulk ice cream is placed in a paperboard package. Then, a fat based ganache coating is applied to the top surface of the ice cream. The package is sealed by placing a paperboard lid over the package portion holding the ice cream and fat based ganache coating.

Ideally, the package is designed in the shape of a cylinder with vertical or tapered sidewalls, that run from top to bottom, with a separate lid for sealing.

In another aspect of the present invention, an embossed or printed design may be placed on the fat based ganache coating. Shortly after application, the fat based ganache coating is still warm, and a stamping or printing device is used to place a design on the coating. The contact time for the stamping or printing device is ideally less than about 2 seconds. As noted previously, the embossing technique described in U.S. patent application Ser. No. 09/341,429, filed Jan. 6, 2000, the disclosure of which is incorporated by reference herein, may be employed. Typically the design will be a logo or brand trademark.

In one embodiment, an outer surface of the fat based ganache coating is contacted with a chilled embossing member having a contacting surface temperature below 0° C. This step is performed prior to sealing the package and results in a product having an embossed fat based ganache surface, preferably one with an embossed image on the fat based ganache surface. Other embodiments are contemplated where the chilled embossing member has a contacting surface temperature below −15° C., −25° C., below −40° C., below −50° C., below −60° C., below −70° C., below −80° C., and below −100° C. In another embodiment, a chilled embossing member is contacted with the fat based ganache coating for a period of time sufficient to form an outer solidified skin sufficiently thick to retain shape after removal of the embossing member. The chilled embossing member is in contact with the fat based ganache coating for a period of time less than 1.5 minutes, preferably less than about 2 seconds, more preferably less than 0.1 second. The fat based ganache coating should at least partially solidify in at least one outer surface layer of the fat based ganache coating during the time that the chilled embossing member is in contact with it. It is worth noting the importance that the fat based ganache coating have the proper texture, e.g., penetration hardness. Otherwise, if the texture of the fat based ganache coating is too soft, the embossed image will not be retained.

In an alternative embodiment, a preformed embossed edible material is applied on a surface of the fat based ganache coating, prior to the step of sealing the package. Preferably, the preformed embossed edible material is the same as the fat based ganache coating. The temperature at which the preformed embossed edible material is applied on to the surface of the fat based ganache coating is less than about −20° C. The fat based ganache coating is preferably a ganache.

For the embossing step, the ice cream may be fully frozen, partially frozen, or soft when said embossing step is performed.

The present invention also includes a method of reducing ice crystal formation in a packaged frozen product. The method comprises the steps of: (a) providing a package having an opening, wherein the package is suitable for storing said frozen product; (b) depositing an edible frozen matrix into the package; (c) applying a fat based ganache coating comprising a compound coating, an edible oil, and water, to at least one surface of the edible frozen matrix, wherein the fat based ganache coating has a penetration hardness at −5° C. of from about 4,400 to about 12,000 grams of force; and (d) sealing the package to fully surround the edible frozen matrix and the fat based ganache coating, thereby substantially reducing the formation of ice crystals. A packaged frozen product manufactured using this method should have no visible ice crystals (Rating of 1) or only a slight thin layer of ice crystals (Rating of 2). In addition, by reducing the formation of ice crystals, the resulting product would maintain the desired eating texture.

### EXAMPLE 1

A fat based ganache coating was made by combining the following ingredients:

68% by wt. dark chocolate

5% by wt. partially hydrogenated soybean oil

15% by wt. vanilla ice cream mix (with 14% milkfat)

12% by wt. water

The ingredients were blended together in a mixing kettle and chilled to a temperature of 26° C.

The resulting ganache had a water activity of 0.86 and a density of 1.174 g/cm³.

A packaging cup was first filled with ice cream followed by the application of a layer of the ganache to the top surface of the ice cream.

### EXAMPLE 2

A fat based ganache coating of the present invention was made using:

62.05% by wt. dark chocolate

12.95% by wt. coconut oil

5.0% by wt. partially hydrogenated soybean oil

15.0% by wt. cream mix

5.0% by wt. water

The ingredients were combined as follows:

1. The cream mix was heated to 3.3° C. and the water was heated to 12° C.

2. The partially hydrogenated soybean oil, coconut oil, and dark chocolate were heated to 38° C.

3. All the ingredients were combined into a mixing pot and stirred together.

The penetration hardness of the resulting product was determined to be 5,500 force grams at −5° C.

### EXAMPLE 3

A fat based ganache coating was made using:

62.05% by wt. dark chocolate

17.95% by wt. coconut oil

15.0% by wt. cream mix

5.0% by wt. water

The ingredients were combined as follows:

1. The cream mix was heated to 3.3° C. and the water was heated to 12° C.

2. The coconut oil and dark chocolate were heated to 38° C.

3. All the ingredients were combined into a mixing pot and stirred together.

The penetration hardness of the resulting product was determined to be 6,500 force grams at −5° C.

### EXAMPLE 4

A 300 gram batch of a water containing chocolate composition (found in U.S. Pat. No. 6,174,555) was made using:

165 g of chocolate

72.6 g of cream mix

22.5 g of water

14.7 g of vegetable oil

7.2 g of anhydrous milk fat

15.0 g of cocoa butter

0.9 g of polyglycerolpolyricinoleate (PGPR)

1.2 g of monoglyceride

0.9 g of soy lecithin

The ingredients were combined as follows:

1. The cream mix and water were heated to 50° C. to 55° C.

2. The vegetable oil, cocoa butter, anhydrous milk fat, PGPR and monoglyceride were heated to 40° C.

3. The ingredients in step 1 were cooled to 40° C. and then combined with the ingredients in step 2 in a mixing blender. The mixture was blended for 20 minutes at an agitator speed of approximately 80 rpms.

4. The resulting mixture was then added to the chocolate and soy lecithin.

The resulting product was determined to have a hardness of 3,300 force grams at −5° C. and a fudge like texture.

### EXAMPLE 5

A commercial brand packaged ice cream product containing milk, cream, sugar, and natural vanilla was subjected to the following conditions:

1. 5 weeks storage in a cycle freezer (−12° C. to −29° C.).

2. 2 weeks storage in a home freezer (−16° C.).

The package was opened and a very heavy layer of ice crystals was visible (product rating of 5).

### EXAMPLE 6

A fat based ganache coating was applied to the top surface of a commercial brand packaged ice cream product (similar to the one used in Example 5). The lid was placed back on and the product was subjected to the following conditions:

1. 5 weeks storage in a cycle freezer (−12° C. to −29° C.).

2. 2 weeks storage in a home freezer (−16° C.).

The package was opened and no visible ice crystals were observed (product rating of 1) on either the fat based ganache coating or on the surface of the ice cream layer.

### EXAMPLE 7

A edible frozen product containing a fat based ganache coating over an edible frozen matrix was embossed using the following procedure:

1. The temperature of the fat based ganache coating was set to 32° C. to 38° C.

2. An aluminum embossing member was chilled in dry ice (temperature of −80° C.).

3. The fat based ganache coating was stamped with the chilled aluminum embossing member for 2 seconds.

4. The stamped product was transferred into a freezer.

While the invention has been described above with reference to specific embodiments thereof, it is apparent that many changes, modifications, and variations can be made without departing from the inventive concept disclosed herein. Accordingly, it is intended to embrace all such changes, modifications, and variations that fall within the spirit and broad scope of the appended claims. All patent applications, patents, and other publications cited herein are incorporated by reference in their entirety.

What is claimed is:

1. A packaged frozen product, comprising (a) an edible frozen matrix, and (b) a fat based ganache coating comprising a compound coating, an edible oil, and water that is applied to at least one surface of said edible frozen matrix, wherein said fat based ganache coating has a penetration hardness at −5° C. of from about 4,400 to about 12,000 grams of force.

2. The product according to claim 1, further comprising (c) a package that surrounds said fat based ganache coating and said edible frozen matrix.

3. The product according to claim 1, wherein said compound coating is from about 50 wt. % to about 85 wt. % based on the total weight of said fat based ganache coating.

4. The product according to claim 1, wherein said edible oil is from about 10 wt. % to about 30 wt. % based on the total weight of said fat based ganache coating.

5. The product according to claim 1, wherein said edible oil is selected from the group consisting of partially hydrogenated soybean oil, cocoa butter, illipe oil, shea oil, palm oil, sal oil, soybean oil, cottonseed oil, palm kernel oil, coconut oil, rapeseed oil, sunflower oil, peanut oil and mixtures thereof.

6. The product according to claim 5, wherein said edible oil is coconut oil.

7. The product according to claim 1, wherein said water is from about 0 wt. % to about 27 wt. % based on the total weight of said fat based ganache coating.

8. The product according to claim 1, wherein said moisture content of said fat based ganache coating is from about 10 wt. % to about 23 wt. % based on the total weight of said fat based ganache coating.

9. The product according to claim 1, wherein said fat based ganache coating further comprises a cream.

10. The product according to claim 9, wherein said cream comprises milk fat, milk solids, and water.

11. The product according to claim 9, wherein said cream is from about 5 wt. % to about 10 wt. % based on the total weight of said fat based ganache coating.

12. The product according to claim 1, wherein said fat based ganache coating completely covers one or more of said at least one surface.

13. The product according to claim 1, wherein said fat based ganache coating partially covers one or more of said at least one surface.

14. The product according to claim 1, wherein said fat based ganache coating is applied in the shape of a designed pattern.

15. The product according to claim 1, wherein said fat based ganache coating is a has a water activity at 25° C. of from about 0.72 to about 0.82.

16. The product according to claim 1, wherein said fat based ganache coating has an overall fat content from about 30% to about 50% by weight.

17. The product according to claim 2, wherein said package has a volume of about a pint.

18. The product according to claim 1, wherein said fat based ganache coating substantially free of visible ice crystals on one or more of said edible frozen matrix surfaces.

19. The product according to claim 1, wherein said edible frozen matrix is ice cream.

20. The product according to claim 1, further comprising an edible cone.

21. A method of making a frozen product, comprising the steps of:
(a) providing an edible frozen matrix;
(b) applying a fat based ganache coating comprising a compound coating, an edible oil, and water to at least one surface of said edible frozen matrix, wherein said fat based ganache coating has a penetration hardness at −5° C. of from about 4,400 to about 12,000 grams of force.

22. The product according to claim 21, wherein said frozen product is placed in a package that fully surrounds said edible frozen matrix and said fat based ganache coating.

23. The method according to claim 21, wherein said fat based ganache coating is applied at a temperature from about 26° C. to about 40° C.

24. The method according to claim 21, further comprising the step of contacting an outer surface of said fat based ganache coating with a chilled embossing member having a contacting surface temperature below 0° C. thereby forming an embossed fat based ganache surface.

25. The method according to claim 24, wherein said chilled embossing member forms an embossed image on said fat based ganache surface.

26. The method according to claim 24, wherein said chilled embossing member is contacted with said fat based ganache coating for a period of time sufficient to form an outer solidified skin sufficiently thick to retain shape after removal of said embossing member.

27. The method according to claim 24, wherein said chilled embossing member is contacted with said fat based ganache coating for a period of time less than 1.5 minutes, thereby at least partially solidifying at least one outer surface layer of said fat based ganache coating.

28. The method according to claim 21, further comprising the step of applying a preformed embossed edible material on a surface of said fat based ganache coating.

29. The method according to claim 28, wherein said preformed embossed edible material is the same as said fat based ganache coating.

30. The method according to claim 29, wherein said preformed embossed edible material is applied on to said surface of said fat based ganache coating at a temperature of about 0° C. or less.

31. The method according to claim 27 or 30, wherein said edible frozen matrix is ice cream that is fully frozen, partially frozen, or soft, when said embossing step is performed.

32. A method of substantially reducing ice crystal formation in a packaged frozen product, comprising the steps of:
(a) providing a package having an opening, wherein said package is suitable for storing said frozen product;
(b) depositing an edible frozen matrix into said package;
(c) applying a fat based ganache coating comprising a compound coating, an edible oil, and water to at least one surface of said edible frozen matrix, wherein said fat based ganache coating has a penetration hardness at −5° C. of from about 4,400 to about 12,000 grams of force; and
(d) sealing said package to fully surround said edible frozen matrix and said fat based ganache coating,
thereby substantially reducing the formation of ice crystals.

33. The method of claim 32, wherein there are no visually detectable ice crystals.

34. A fat based ganache coating comprising:
(a) about 50 wt. % to about 85 wt. % of a compound coating;
(b) about 10 wt. % to about 30 wt. % of an edible oil; and
(c) about 5 wt. % to about 25 wt. % of water,
wherein said fat based ganache coating has a penetration hardness at −5° C. of from about 4,400 to about 12,000 grams of force.

35. The fat based ganache coating of claim 34, further comprising a flavoring component.

36. The fat based ganache coating of claim 34, further comprising a coloring component.
